(19) United States
(12) Patent Application Publication
(10) Pub. No.: US 2017/0136618 A1
(43) Pub. Date: May 18, 2017

(54) HANDLE FOR HAND TOOL

(71) Applicant: CHING-CHING TSAI, Taichung City (TW)

(72) Inventor: CHING-CHING TSAI, Taichung City (TW)

(21) Appl. No.: 14/940,203

(22) Filed: Nov. 13, 2015

(51) Int. Cl. B25G 1/10; B25B 23/16; B25B 15/04

(52) U.S. Cl. CPC B25G 1/102; B25B 15/04; B25B 23/16

(57) ABSTRACT

A handle of a hand tool includes a body made of a first material and a bit is connected to the bottom of the body. A buffering portion made of a second material integrally formed to the outside of the body. The second material has a proper elasticity and is less hard than the first material. A grasp portion made of a third material integrally formed with the buffering portion. The second material is less hard than the third material. The grasp portion has multiple recess for easily grasp by the user. The buffering portion buffers or absorbs the shifting of the grasp portion to maintain the bit to be perpendicular to the top face of the bolt head so as to effectively drive the bolt.

### BACKGROUND OF THE INVENTION

1. Fields of the Invention

The present invention relates to a handle of a hand tool, and more particularly, to a handle of a hand tool and the handle has a buffering portion which allows the user's hand to the handle comfortably.

2. Descriptions of Related Art

The conventional hand tool such as a screwdriver generally comprises a handle and a shaft which extends from the handle. The shaft has a function end so as to be engaged with the head of a bolt for example. The user grasps the handle and rotates the hand tool to tighten or loosen the bolt. During rotating the hand tool, the user has keep the hand tool to be perpendicular to the top face of the bolt, once the shaft is inclined relative to the top face of the bolt, the bolt cannot be effectively rotated.

If the hand tool does not have a ratchet mechanism, the user has to rotate the hand tool to an angle, and then remove the hand from the handle and re-grasp the handle to a proper position so as to continue the rotational action. This takes a lot of time and reduces the efficiency.

The present invention intends to provide a handle of a hand tool to eliminate the shortcomings mentioned above.

### SUMMARY OF THE INVENTION

The present invention relates to a handle of a hand tool and comprises a body made of a first material and a bit is connected to the bottom of the body. A buffering portion made of a second material is integrally formed to the outside of the body, and the second material has a proper elasticity and is less hard than the first material. A grasp portion made of a third material is integrally formed with the buffering portion. The second material is less hard than the third material.

Preferably, the buffering portion has at least one protrusion extending therefrom. The at least one protrusion is substantially perpendicular to the axis of the body. The grasp portion is integrally formed with the at least one protrusion.

Preferably, a cap is connected to the top of the body and the buffering portion.

Preferably, the body has an annular groove defined in the top thereof, and the cap has multiple engaging portions which are engaged with the annular groove such that the cap is rotatable relative to the body and the grasp portion.

Preferably, the grasp portion has multiple recesses defined in the outer periphery thereof.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a partial cross sectional view of the handle of the present invention;

FIG. 2 is a partial cross sectional view of another embodiment of the handle of the present invention;

FIG. 3 is a top end view of another embodiment of the handle of the present invention without the cap;

FIG. 4 is a cross sectional view, taken along line A-A in FIG. 3, wherein a cap is connected to the body;

FIG. 5 is a bottom end view of the handle of the present invention in FIG. 4, and

FIG. 6 is a top end view of yet another embodiment of the handle of the present invention without the cap.

### DETAILED DESCRIPTION OF THE PREFERRED EMBODIMENT

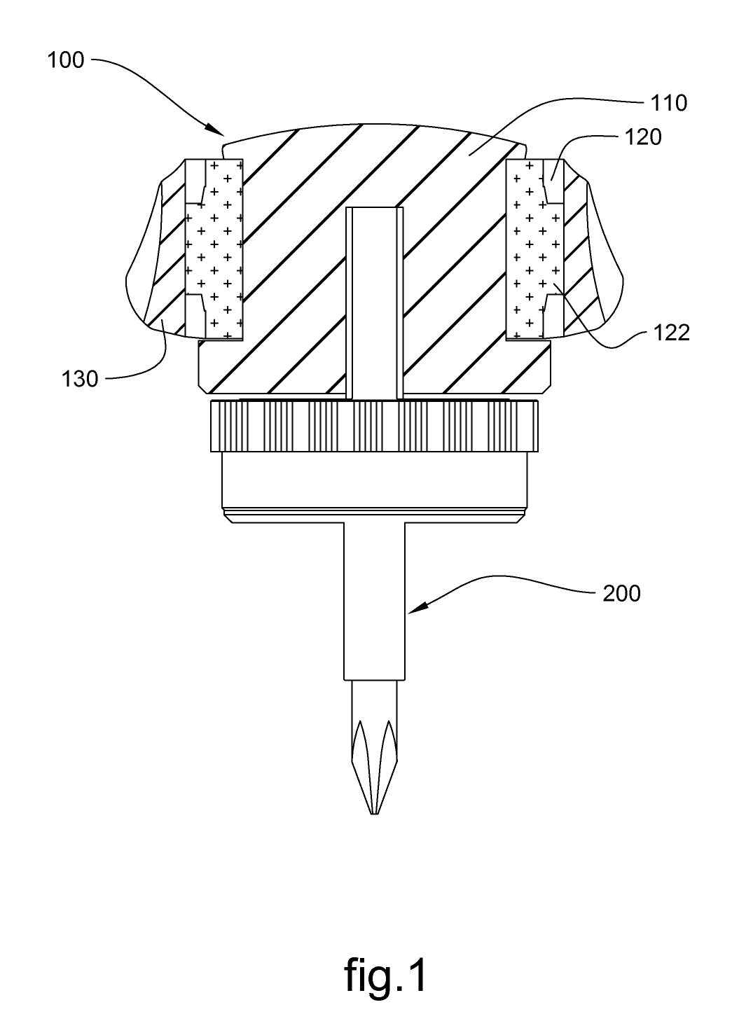

Referring to FIG. 1, the handle 100 of the present invention comprises a body 110 made of a first material and a bit 200 is connected to the bottom of the body 110. The bit 200 can be driven by a ratchet mechanism. The first material is formed by way of injection molding. A buffering portion 120 made of a second material is integrally formed to the outside of the body 110, wherein the second material is less hard than the first material. In other words, the second material has a proper elasticity. The buffering portion 120 has multiple protrusions 122 extending therefrom, wherein the profusions 122 are substantially perpendicular to an axis of the body 110. A grasp portion 130 made of a third material is integrally formed with the buffering portion 120, the second material is less hard than the third material. The third material is also made by way of injection molding.

When manufacturing the handle 100, the body 110 and the grasp portion 130 are respectively made by way of injection molding, and the second material of the buffering portion 120 is injected between the grasp portion 130 and the body 110 to integrally form the handle 100 without any seam.

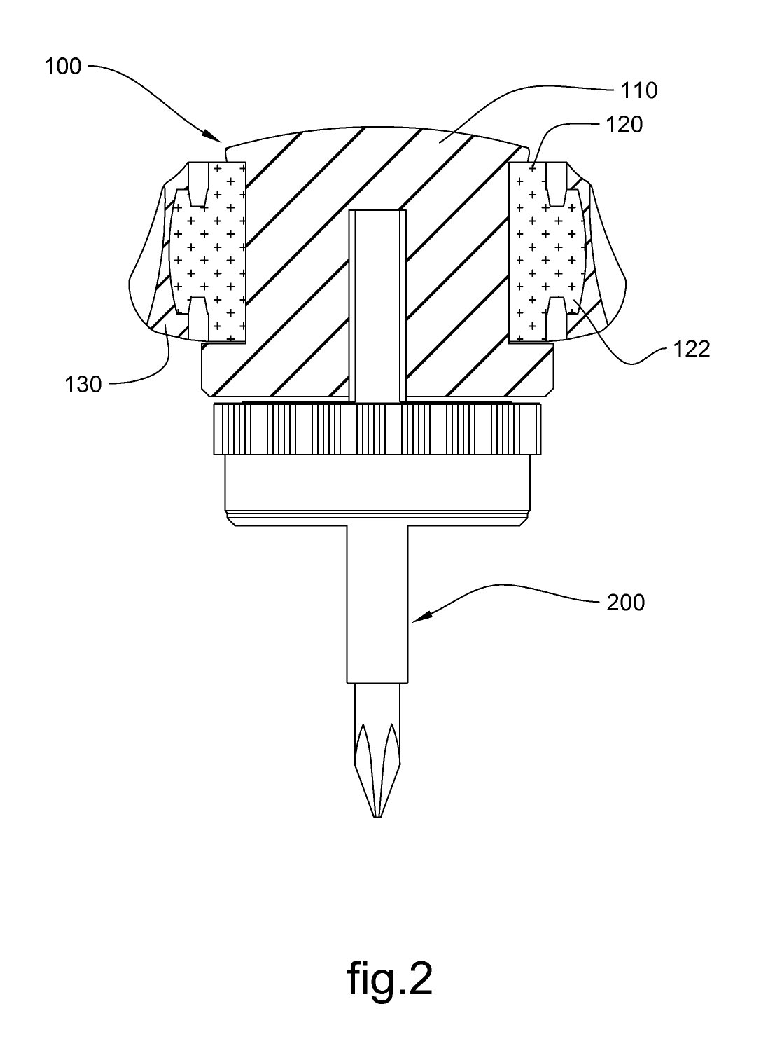

FIG. 2 shows another embodiment of the present invention, wherein the handle 100 comprises the body 110, the buffering portion 120 and the grasp portion 130, the difference from the previous embodiment is that when injecting the second material of the buffering portion 120, the protrusions 122 are partially or entirely embedded by the grasp portion 130 to enhance the connection between the buffering portion 120 and the grasp portion 130.

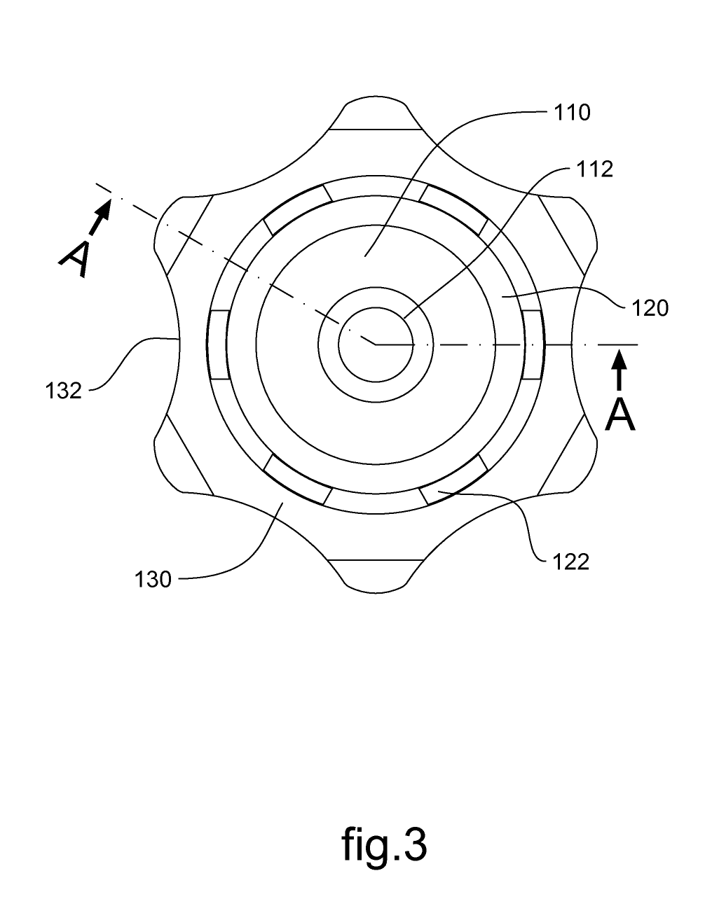

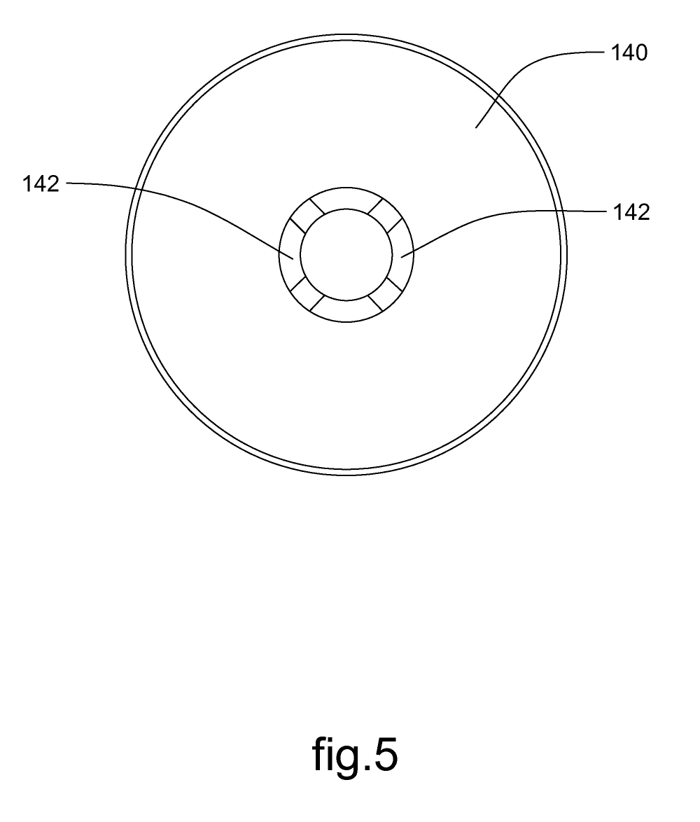

FIGS. 3 to 5 show another embodiment of the handle of the present invention, wherein the handle 100 comprises the body 110, the buffering portion 120, the grasp portion 130 and the cap 140. The bit 200 connected to the body of the body 110 is a straight bit. The buffering material 120 is connected to the outside of the body 110 and has multiple protrusions 122. The grasp portion 130 is connected to the outside of the buffering portion 120. The material of the buffering portion 120 is less hard than that of each of the body 110 and the grasp portion 130. The grasp portion 130 has multiple recesses 132 defined in the outer periphery thereof so that the user can easily and firmly grasp the handle 100.

The cap 140 is connected to the top of the body 110 and the buffering portion 120. The cap 140 has a curved top surface and has multiple engaging portions 142 which are separated from each other by a distance. The body 110 has an annular groove 112 defined in the top thereof, and the engaging portions 142 are engaged with the annular groove 112 such that the cap 140 is rotatable relative to the body 110 and the grasp portion 130. Therefore, by pressing the cap 140, the bit 200 can be engaged with the bolt without shifting.

When in use, the user presses the cap 140 and holds the body 110 to rotate the bit 200 to tighten or loosen the bolt, the cap 140 is rotatable relative to the body 110 so that the rotation of the cap 140 does not drive the body 110, such that the bit 200 does not disengaged from the bolt and does not shift relative to the bolt.

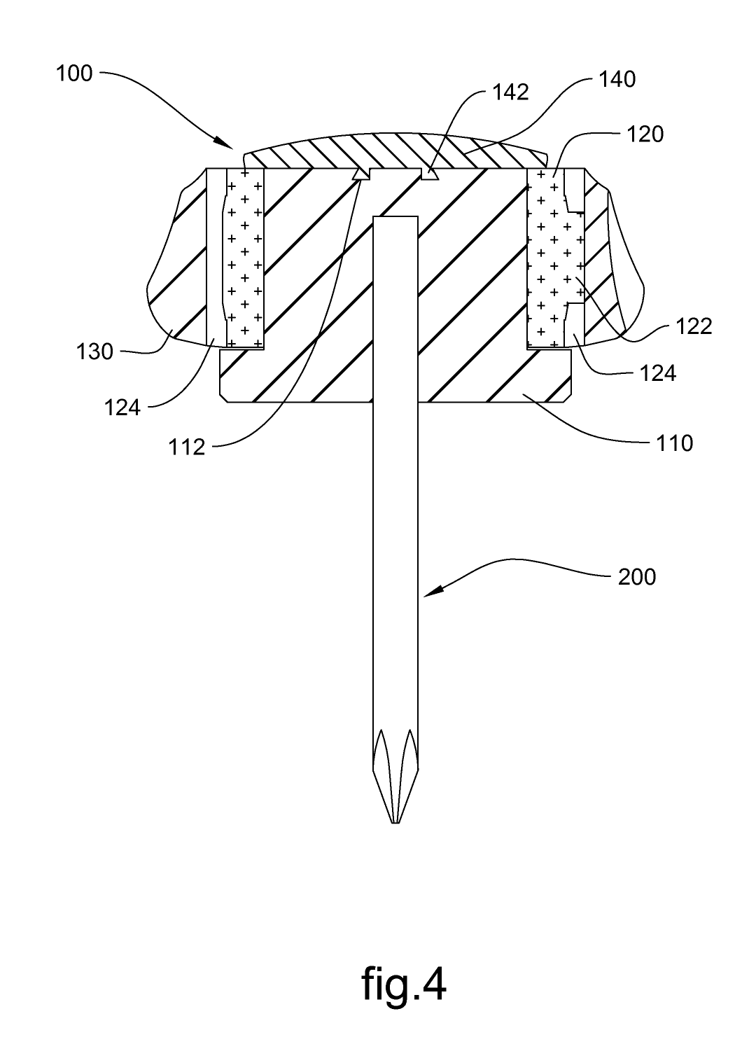

The grasp portion 130 is integrally formed with the protrusions 122 of the buffering portion 120, and the grasp portion 130 is not directly connected to the body 110 so that there is a room 124 formed between the grasp portion 130 and the body 110, as shown in FIG. 4, and also there is a room 124 between any of the two protrusions 122. There is a room respectively located above and beneath the single protrusion 122 as well. The buffering portion 120 is made by the material that is softer than the material of the body 110 and the grasp portion 130, so that the minor shifting of the grasp portion 130 can be buffered or absorbed by the buffering portion 120 such that the body 110 does not shift and the bit 200 does not removed from the bolt. In other words, even if the grasp portion 130 shifts, the bit 200 is still maintained at the proper position to effectively drive the bolt.

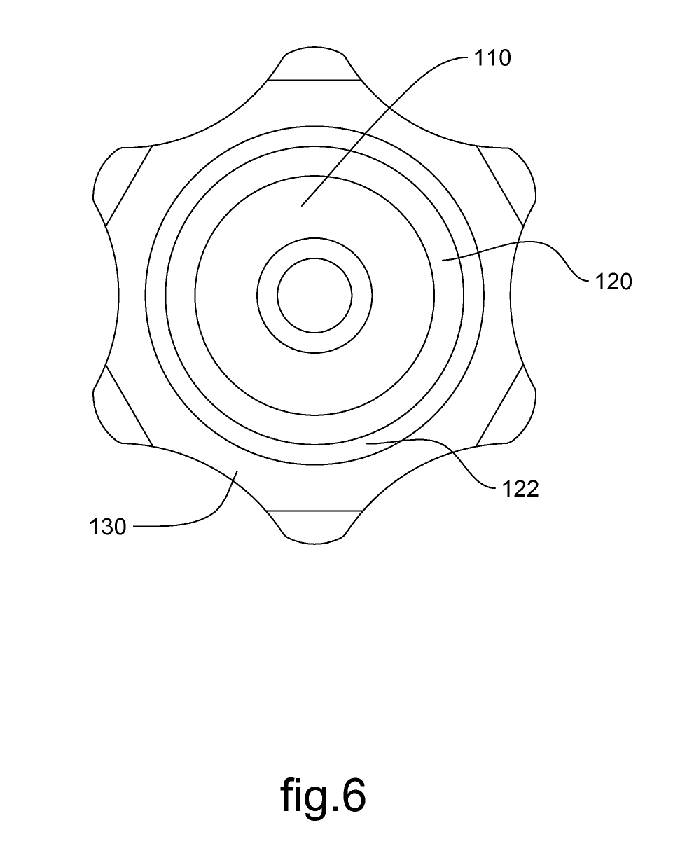

FIG. 6 shows another embodiment of the present invention, the difference from the previous embodiment is that the protrusions 122 of the buffering portion 120 is a single protrusion 122 which is an annular flange between the buffering portion 120 and the grasp portion 130.

While we have shown and described the embodiment in accordance with the present invention, it should be clear to those skilled in the art that further embodiments may be made without departing from the scope of the present invention.

What is claimed is:

1. A handle of a hand tool, comprising:
a body made of a first material and adapted to be connected with a bit;
a buffering portion made of a second material and integrally formed to an outside of the body, the second material having elasticity and being less hard than the first material, and
a grasp portion made of third material and integrally formed with the buffering portion, the second material being less hard than the third material.

2. The handle as claimed in claim 1, wherein the buffering portion has at least one protrusion extending therefrom, the at least one protrusion is substantially perpendicular to an axis of the body, the grasp portion is integrally formed with the at least one protrusion.

3. The handle as claimed in claim 1, wherein a cap is connected to a top of the body and the buffering portion.

4. The handle as claimed in claim 3, wherein the body has an annular groove defined in the top thereof, the cap has multiple engaging portions which are engaged with the annular groove such that the cap is rotatable relative to the body and the grasp portion.

5. The handle as claimed in claim 1, wherein the grasp portion has multiple recesses defined in an outer periphery thereof.
